(19) United States
(12) Patent Application Publication
(10) Pub. No.: US 2025/0128486 A1
(43) Pub. Date: Apr. 24, 2025

(54) TIRE FLAT PROOFING TIRE FILLING METHOD

(71) Applicant: American Polymers Corporation, Santa Fe Springs, CA (US)

(72) Inventor: John Danules, Arlington, TX (US)

(21) Appl. No.: 18/492,534

(22) Filed: Oct. 23, 2023

(51) Int. Cl. B29D 30/04; B60C 23/04; B60C 29/06

(52) U.S. Cl. CPC B29D 30/04; B60C 23/04; B60C 29/062

(57) ABSTRACT

Methods and systems are contemplated in which elastomer materials can be processed into flatproofing materials which may be used to produce flatproofed tires. A elastomer material can be extruded through an extrusion die to produce two or more elastomer chunks. These elastomer chunks can be ground into a granulated material, which may comprise a flatproofing material to be used to fill a tire. Air in the tire may escape through a hole in the tire, and this air can be guided through a vent wherein an air flow meter can measure the air's flow rate. If the measured air flow rate drops below a threshold value, the process of filling the tire with the flatproofing material can be ceased. The tire can be investigated, after which the tire may be further filled with the flatproofing material before sealing the hole in the tire to produce the flatproofed tire.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Methods of filling vehicle tires with flatproofing materials to produce flatproofed tires have been known and used in the art throughout the last 50 years. Typically, tires are made flatproofed by puncturing a hole in the tire and feeding flatproofing material into the tire to displace the air that would normally be present. The air in the tire can be steadily replaced by the flatproofing material, since the air can escape through the hole created by the puncture. Once a certain amount of flatproofing material has been pumped into the tire, the hole can be sealed and pressurized to rated pressure to finish the flatproofed tire product. This tire may be superior to ordinary air-filled tires in that they are not as prone to explosive decompression when punctured and can deliver maximum tire life due to maintaining specified air pressure. Flatproofed tires are particularly useful when used on heavy vehicles and/or vehicles that would drive on off-road, unpredictable terrain where long lasting and durable tires are at times a necessity. Specialized vehicles, such as those used in applications like construction, mining, waste management, agriculture, and more, may particularly take advantage of flatproofed tires.

The flatproofing material can be composed of a liquid component, usually polyurethane liquid, and a solid elastomer material like toluene diisocyanate. U.S. Pat. No. 6,918,979 entitled “METHOD FOR MAKING TIRES FILLED WITH FLATPROOFING MATERIAL”, the disclosure of which is incorporated herein by reference in its entirety, improved upon prior art methods by introducing dry granulated material into the flatproofing material, with this dry granulated material originating from ground rubber tires or old cured flatproofing material removed from worn out tires, which particularly may include the tire fill of those tires. The granulated material could be obtained by cutting old tires into smaller chunks which may then be grinded down into a fine pulverulent. The abundance of these old, worn-out tires gave way to low material costs in producing the flatproofing material.

However, several of the methods currently performed to make flatproofed tires have numerous shortcomings that make them less efficient and even dangerous in many cases to carry out. First, the task of chunking a whole tire fill donut or a portion thereof into smaller chunks commonly entails the use of nonideal and non-safe equipment. When these chunks have been cut down to a proper size, they can be fed into a grinder wherein they may be further processed into the proper granulated size range for flatproofing, but the practices conventionally employed for chunking the tire fill involves using handheld electric saws and repurposing log splitters, both of which are challenging to use and have thus given operators devastating injuries. Another noticeable drawback in these methods is the failure to efficiently identify and remove chunks containing metallic species. Old tires, over the course of their use, may have accumulated metallic species, which could damage the grinder the elastomer tire fill is fed into or the metering auger which feeds the flatproofing material into the tire. Currently, there isn't an efficient method to identify these select chunks from a larger group of chunks and separate them from the rest of the group before being introduced to a grinder without slowing down the overall process significantly.

Finally, there has yet to be an efficacious method of monitoring and tracking the process of filling the tire with the flatproofing material. The tire can easily become overfilled, via pumping in too much flatproofing material, the air in the tire not sufficiently escaping, or a combination thereof. Air not sufficiently escaping is the more common issue, as the punctured hole can easily become blocked during the filling process, not have a sufficiently large area, not be deep enough into the tire, etc. Operators usually monitor air flow out from a tire during the tire filling process by holding one of their hands over the hole to feel if the air is sufficiently escaping. Failure by the operator to closely monitor the escaping air puts the operator in extreme danger in case the tire becomes over pressurized and explodes. Therefore, it can be seen that new and improved methods are desirous for producing flatproofing materials and filling a tire with those flatproofing materials to produce flatproofed tires.

### BRIEF SUMMARY

To solve these and other problems, improved methods and systems are disclosed in which elastomer materials can be efficiently broken up into smaller elastomer chunks via extrusion of the elastomer material through an extrusion die. Now easier to process owing to their smaller size, the elastomer chunks can be fed into a grinder to produce a granulated material to compose a flatproofing material. A tire containing air may begin to be filled with a flatproofing material, causing the air to be forced out of the tire through a hole in the tire. The flow rate of the air escaping from the tire can be measured, and when this flow rate drops below a threshold value, the process of filling the tire can be stopped, allowing one to investigate the tire. If the tire is at risk of exploding due to a buildup of the air in the tire, preventative measures can be taken, such as unblocking the hole in the tire, to allow air trapped in the tire to escape. The process of filling the tire with the flatproofing material may then continue until the tire is satisfactorily filled with the flatproofing material, after which the hole may be sealed.

A method according to the disclosure herein may comprise the steps of extruding a elastomer material through an extrusion die to produce two or more elastomer chunks, grinding the elastomer chunks down into a granulated material, at least partially filling a tire with the granulated material, measuring the flow rate of air escaping from a hole in the tire, ceasing the filling of the tire with the granulated material, and sealing the hole in the tire. Another step of investigating the tire, which could comprise determining the amount of air left in the tire, the amount of granulated material in the tire, if the hole is improper, if the hole has been blocked, and combinations thereof, may also take place. Once the tire has been investigated, and any measures have been taken to remedy the tire's pressurization or the filling process, additional steps of filling the tire with some of the remaining granulated material and ceasing the filling of the tire with this remaining granulated material may occur.

The elastomer material may be extruded through the extrusion die via a piston forcing the elastomer material against the extrusion die. The extrusion die may comprise one or more edges defining one or more voids therebetween. The edges may be constructed to aid in the extrusion process, such as by having sharp points which can burrow into the elastomer material and help to break it up into the two or more elastomer chunks. These elastomer chunks can be scanned by a metal detector, and any elastomer chunks containing too much metal can be separated from the rest of the elastomer chunks before being grinded down into the granulated material. The used tire fill could alternatively, prior to being extruded, scanned with metal detectors, which could be carried out via suspending the tire donut or a portion thereof from a sling, such as a nylon or other non-metallic sling, and scanning around the outside diameter of the donut and the inside diameter of the donut using a handheld metal detecting wand of sufficient power. If no metal contamination is found, the donut can be transported to the extruder and processed.

The granulated material can be mixed with additive substances to form a flatproofing material to be used to fill a tire. One example of these substances includes a polyurethane which can be selected from toluene diisocyanate, diphenylmethane diisocyanate, paraphenylene diisocyanate, toluidine diisocyanate, 1,5-naphthylene diisocyanate, polyester, polyether, polycaprolactone, polycarbonate, 1,4-butanediol, 1,3-propanediol, and combinations thereof.

An air flow meter may be positioned in a fluid pathway of the air escaping from the tire so that it may measure the flow rate of the escaped air. The hole in the tire through which the air can escape through can be made directly, such as with an operator using a tool or with machinery operative to make the hole. Another step can be performed in which a duct having a passageway can be coupled to the tire. Such coupling can be associated with the hole in the tire so that when the air in the tire escapes through the hole, the air travels through the passageway of the duct. A portion of the air flow meter can be positioned in the duct, which may allow the air flow meter to more accurately measure the flow rate of air escaping from the tire, as the air flow from the tire can be shielded from other air flows in close proximity to the tire's hole.

The present disclosure may embody itself in the form of a flatproofed tire system comprising an extrusion system and a tire filling system. The extrusion system may comprise the piston and extrusion die, while the tire filling system can comprise a housing, the duct, the air flow meter, and a hose for supplying the flatproofing material. The housing may incorporate a weight sensor operative to measure the weight of the tire, which could help to inform one of the amounts of air and flatproofing material contained in the tire. The speed of the piston during the extrusion process can be adjusted from zero to a maximum speed and speeds therebetween. Similarly, the flow rate of the flatproofing material through the hose and into the tire can be adjusted from zero to a maximum flow rate and flow rates therebetween.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an exemplary extrusion system receiving a elastomer material;

FIG. 2 is a perspective view of an exemplary extrusion die;

FIG. 3 is the same perspective view of the extrusion system of FIG. 1, with the extrusion processing being portrayed; and

FIG. 4 is an exemplary tire filling system and tire filling process.

Common reference numerals are used throughout the drawings and the detailed description to indicate the same elements.

### DETAILED DESCRIPTION

Contemplated herein are improved methods and systems in which flatproofing materials may be made and how those flatproofing materials can be used to produce a flatproofed tire. Elastomer materials, which can include waste materials like used tire fill from the inside of a worn tire, can be cut into smaller elastomer chunks via extrusion of the elastomer material through an extrusion die. When processed into a granulated material, the elastomer chunks could at least partially compose a flatproofing material. This flatproofing material may be introduced into a tire to begin to form the flatproofed tire. The tire may have a hole, which could be directly made by puncturing the tire, through which air contained in the internal volume of the tire may escape. As the flatproofing material is introduced into the tire, the air contained in the tire's internal volume may gradually escape through this hole. The flowrate of air escaping from the tire in this manner can be measured, and when this measured flowrate drops below a threshold value, the process of filling the tire with the flatproofing material can be stopped and the tire can be investigated to determine if the hole was inadvertently blocked or if the hole was not sufficiently made. This may guide an operator to reopen the hole or fix the hole before the filling process may start again. Alternatively, the operator may recognize that the low flow rate could be a result of the air having sufficiently escaped from the tire. When a sufficient amount of flatproofing material has been introduced to the tire, the hole may be sealed, after which the tire can be filled further with the flatproofing material, if necessary to reach a specified internal pressure, which may depend on the type of tire and intended application for that tire. Once finished, the desired flatproofed tire product may be produced.

This disclosure will be best understood with respect to the figures, in which exemplary embodiments according to the methods and system disclosed herein are shown. The claimed systems and methods, however, are not to be limited by these depictions and the discussions thereof, as the components therein may have differing geometries, spatial relationships with one another, and/or additional/less features in actual embodiments while still remaining in the spirit and scope of the methods and systems disclosed herein.

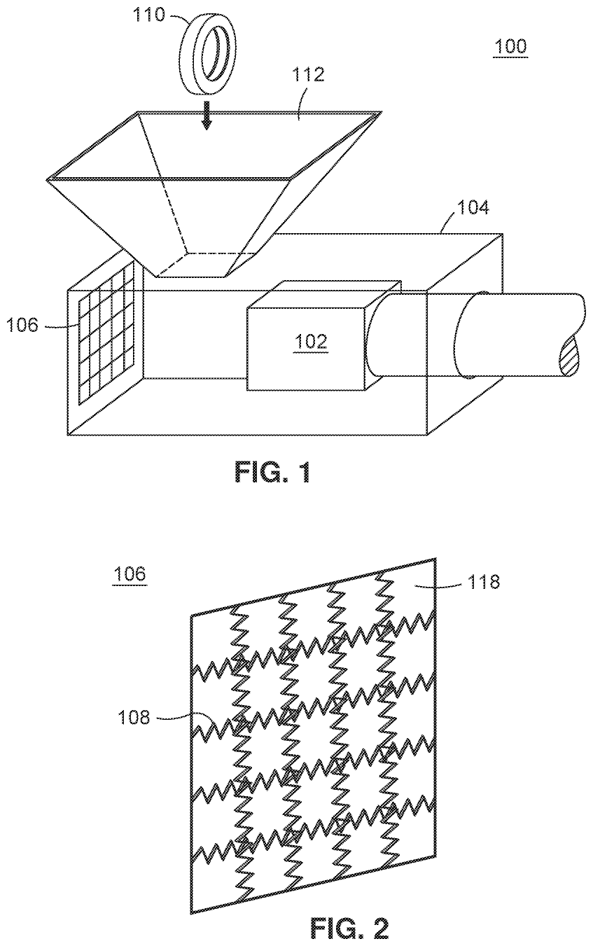

Looking first to FIG. 1, a perspective view of an exemplary extrusion system is shown. The extrusion system 100 may comprise a housing 104 which may at least partially enclose one or more of the components of the extrusion system 100. The housing 104 in this FIG. 1 has been made transparent in this perspective view so that the internal components of this extrusion system 100 may be seen; in actual embodiments the housing could be made completely of a transparent material, made only partially by a transparent material, or not made of a transparent material at all. The transparent material could include a window granting an operator a line of sight to the inside the housing 104. The housing 104 may protect the internal components of the extrusion system 100 and/or shield the surrounding environment from the extrusion process, as small chunks and/or particulate matter of the elastomer material 110 could shoot or fly outwards, potentially causing harm to people around the extrusion system 100. The extrusion system 100 may further comprise a piston 102. The piston 102 may be in a horizontal orientation, but alternative pistons in other extrusion systems may be oriented vertically or some intermediate orientation between horizontal and vertical (i.e., diagonally oriented). The piston 102 could be shaped rectangularly but can take form in any type of geometric shape (such as more cylindrical, triangular, and more abstract shapes). The shape of the piston 102 could also incorporate more than one geometric shape. An extrusion system need not have just one piston, and pistons may be positioned anywhere throughout an extrusion system.

The extrusion system 100 may be operative to receive a elastomer material 110. This elastomer material 110 may be any type of material suitable for use in flatproofing materials; as such the elastomer material 110 may include, but it is not limited to, butadiene elastomer, styrene-butadiene elastomer, halogenated polyisobutylene elastomer, nitrile butadiene elastomer, hydrogenated nitrile butadiene elastomer, and combinations thereof. A elastomer material 110 previously used and no longer needed in a separate application may be repurposed and recycled by using it within the extrusion system 100, and/or an unused elastomer material, including elastomer materials made specifically for use in the extrusion system 100, can be extruded in the extrusion system 100. One example of a recyclable elastomer material 110 the extrusion system 100 could use is a tire fill previously used in a vehicle. The waste tire fill could be the whole elastomer tire fill structure (the whole donut-like shape), or it could be a portion thereof in case a damaged or destroyed waste tire fill with one or more missing pieces is being used. The extrusion system 100 may also be capable of receiving and extruding more than one elastomer material 110, each of which could be shaped and sized differently from one another or similar to one another.

The extrusion system 100 may receive the elastomer material 110 by placing the elastomer material 110 within a hopper 112, which may allow the elastomer material 110 to drop into the extrusion system 100 via gravity. An extrusion system could have other entryways, in addition to the hopper 112 or in place of the hopper 112, like conduits and openings through which the extrusion system could similarly receive the elastomer material 110. Any entryway may allow the elastomer material 110 to be safely placed in the extrusion system 100 while avoiding the need for an operator to reach far inside the extrusion system 100 and put themselves in harm's way of the piston 102 and extrusion die 106. Any of these entryways through which the extrusion system 100 can receive the elastomer material can be operative to be closed, preventing objects from moving into or out of the extrusion system 100 through that entryway. The entryway could incorporate a feature to cause this closure, such as with a door operative to block the entryway, and/or the entryway could be operative to deform or somehow change shape to close off the entryway. It may be beneficial to close off the entryway(s) when the extrusion system 100 is carrying out the extrusion procedure, since that can prevent elastomer chunks and particulate matter from flying out of those entryways and potentially harming people around the extrusion system 100. One or more of the entryways could also serve further purposes, such as allowing one to replace the internal components of the extrusion system 100 and/or creating a port through which the extrusion system 100 can be cleaned.

The extrusion system 100 may also comprise an extrusion die 106. As will soon be shown and elaborated upon, the elastomer material 110 may be extruded through the extrusion die 106 to form two or more smaller elastomer chunks of that elastomer material. The extrusion die 106 could be capable of being separated from the extrusion system 100 and recoupled with the extrusion system 100 as desired. The original extrusion die can be cleaned and/or repaired before recoupling it back with the extrusion system 100, or alternatively a different extrusion die can be coupled to the extrusion system 100 to replace the original extrusion die. Thus, the same extrusion system 100 can be used for different applications in which different extrusion dies may be more suitable by replacing one extrusion die for another. The extrusion die 106 can be coupled to the extrusion system 100 via a number of attachment mechanisms, including bolting the extrusion die 106 to the extrusion system 100, adhering the extrusion die 106 to the extrusion system 100, tethering the extrusion die 106 to the extrusion system 100, interlocking the extrusion die 106 to the extrusion system 100 or vice versa (such as by fitting the extrusion die 106 into a socket of the extrusion system such that the two are coupled together by friction), torsional coupling of the extrusion die 106 to the extrusion system 100, and more. Combinations of these attachment mechanisms can be used to couple an extrusion die 106 to an extrusion system 100.

Turning now to FIG. 2, a perspective view of an exemplary extrusion die is depicted. An extrusion die 106 may have edges 108 which can define voids 118 therebetween. The extrusion die 106 can be in a grid-like pattern in which the edges 108 define rectangular shaped voids 118 therebetween, but other patterns and spatial arrangements of edges can be used to define differently shaped voids. Similarly, the size, shape, and number of edges 108 and voids 118 need not be limited to the depiction of this extrusion die 106. It can be seen that the extrusion die 106 can be constructed to achieve certain types of elastomer chunks from the extrusion process. For example, smaller voids resulting from more edges can cause the elastomer material to be cut into even smaller chunks. Also, the edges can be shaped so that the resultant voids cause a certain type of shape of a elastomer chunk to be made from the extrusion process. Portions of an extrusion die 106 could also not have any edges or voids and could instead be of a smooth surface with no edges 108 or voids 118.

An extrusion die 106 and the edges 108 thereof may ideally be made from a strong, rigid material so that the extrusion die 106 is operative to cut the elastomer material 110 into the elastomer chunks when the elastomer material 110 is forced upon the extrusion die 106. In a preferred embodiment, each of the edges 108 are fabricated from steel plates welded in the grid pattern similar to the one shown in FIG. 2, although alternative metals or other types of rigid materials can be used as well in other embodiments. Multiple different types of materials may compose an extrusion die 106 and its edges 108 as well. The edges 108 of the extrusion die 106 may be constructed to aid in the extrusion process. As an example, the edges 108 could be sharp and point outwards towards the direction where the elastomer material may approach the extrusion die 106 from (i.e., towards the piston 102). These sharp points can aid in the extrusion process, as they may penetrate the elastomer material and/or apply stress to the elastomer material to allow it to more easily break up into smaller pieces, as those skilled in the art would readily understand. The sharp point could be one smooth blade that spans the entirety of an edge 108 or a portion thereof, and/or there could be multiple distinct sharp points spaced from each other and/or packed together (like sharp teeth) on an edge 108. Not all of the edges 108 and not the entirety of an edge 108 need to have these sharp points, and that could prove beneficial in case a elastomer material 110 is particularly strong in one region and the sharp edges of an extrusion die correspond to that strong region. Multiple extrusion dies can be used in one extrusion system, one example being that the extrusion dies can be layered next to each other, with the piston 102 being capable of forcing the elastomer material 110 through each of the extrusion dies.

An extrusion die 106 could be generally flat and approximately parallel throughout to a geometric plane (similar to the extrusion die 106 depicted in FIG. 2) but the shape of an extrusion die need not be limited in this aspect. An extrusion die or portions thereof can extend in any direction, examples including a concave configuration or a convex configuration, which depending on the shape and nature of the elastomer material may aid in the extrusion process since certain constructions of the extrusion die 106 can apply stress and cause fracturing to certain elastomer materials better than others, as would be understood by those skilled in the art.

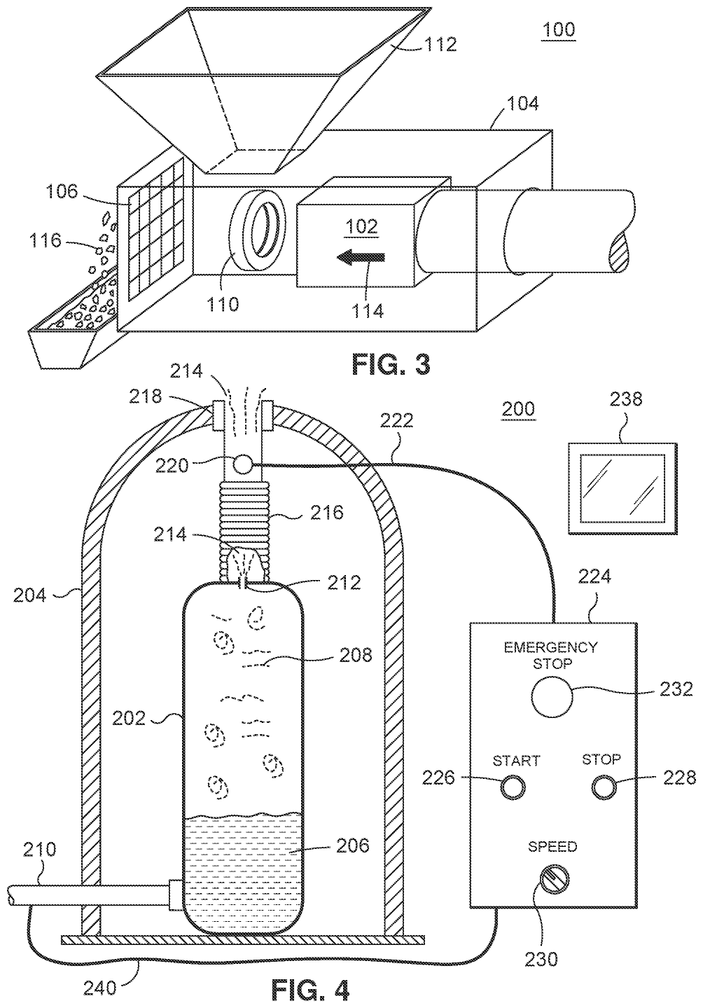

Bringing our attention now to FIG. 3, the same perspective view of the extrusion system of FIG. 1 is shown, with the extrusion processing being portrayed. Here, the waste tire fill donut 110 has been placed inside the extrusion system 100. While not present in this extrusion system 100, an extrusion system could have a socket, indentation, pegs, or a similar component which can help to position the elastomer material 110 in the extrusion system 100. These types of features could prove beneficial in case one desires to produce a certain shape or size of a elastomer chunk 116, as that could be associated with a certain orientation and positioning of the elastomer material 110 and the type and construction of the extrusion die 106 used. Also, certain positionings of the elastomer material 110 may allow it to more easily interact with the piston 102 to ensure the extrusion process is carried out effectively. The piston 102 may be movable in at least a direction of extrusion 114. When moving in the direction of extrusion 114, the piston 102 may be operative to push the elastomer material 110 against the extrusion die 106. Preferably, the direction of extrusion 114 may point towards the extrusion die 106, although certain embodiments of the extrusion system 100 may have a direction of extrusion not pointing directly towards the extrusion die 106 while still causing the elastomer material 110 to be extruded through the extrusion die 106.

The entirety of the piston 102 could move in the direction of extrusion 114 (i.e., translational movement of the piston 102 structure), or a portion of the piston 102 may move in the direction of extrusion 114. Conventional mechanisms used in the art can be used to cause the movement of the piston 102 to extrude the elastomer material 110 through the extrusion die 106; in this respect the features of machine pressers like hydraulic pressers can be used to move the piston 102. The piston 102 may be operative to be coupled with an attachment which may aid in the extrusion process, such as an end piece shaped in a manner so that the elastomer material 110 may fit into or more easily interact with the movement of the piston 102. An example of an attachment includes a flat, steel plate which can be coupled to the piston 102 to act as a moving wall which can push the elastomer material 110 onto the extrusion die 106. This movable wall may be sized to fit in the housing 104 and can be sized to correspond to the area of the extrusion die 106. Any type of geometry can be used on an attachment for a piston 102, and multiple attachments can be coupled to a piston 102. It can be seen that as the piston 102 pushes the elastomer material 110 against the extrusion die 106, the elastomer material 110 can break up into smaller elastomer chunks 116.

The operation of the movement of the piston 102 in the direction of extrusion 114 can be varied by a control mechanism. This control mechanism may be built into the extrusion system 100 or be separate, and this would include devices directly connected to the extrusion system 100 or devices capable of communicating with the piston 102 wirelessly. This control mechanism may allow for the speed of the piston in the direction of extrusion 114 or any direction the piston 102 is movable in to be varied from a speed of zero (wherein the piston 102 does not move in that direction), a maximum speed (which may depend on the configuration of the piston 102 and the overall extrusion system 100), and speeds therebetween. The piston 102 may be operated in a cycle for a particular piece or batch of elastomer materials 110, in which the piston 102 moves in the direction of extrusion 114, optionally pauses for a moment, and moves backwards or away from the extrusion die 106. This cycle can be repeated until the elastomer material 110 has been extruded to a satisfactory degree. Preset variables could dictate this process, like by selecting a preset speed(s) of the piston 102 throughout the different stages of the cycle (and this speed can be changed within a certain stage), a preset timing for transitioning between the stages of the cycle, a preset position the piston 102 will be positioned at/move to, etc. Each of these variables can be changed as desired, allowing one to modify the operation of the extrusion system 100 for different types of elastomer materials 110. An extrusion system can have more than one piston, each of which can have unique or similar directions of extrusion depending on their positioning in the extrusion system 100, and all of which can be operated independently of one another or altogether at the same time.

The elastomer chunks 116 produced through this extrusion process could be more easily processed into a granulated material when compared to the original elastomer material 110 from which those elastomer chunks 116 originated from. Ideally, the elastomer chunks 116 could be no more than 25 pounds The elastomer chunks 116 produced from the extrusion process can be fed into a grinder, which could include grinders conventionally known and used by those skilled in the art, that can be operative to receive the elastomer chunks 116 and grind them into a granulated material. This granulated material can be used in a flatproofing material, either as the flatproofing material itself or as a subcomponent thereof, for producing a flatproofed tire. The grinder and the extrusion system 100 can be spatially related to each other such that the elastomer chunks 116 fall into the grinder once they have extruded from the extrusion system 100. Similar to the extrusion system 100, the grinder could utilize entryways like a hopper to better funnel these elastomer chunks 116 into the grinder.

However, a benefit may be gained by analyzing the elastomer chunks 116 and separating certain elastomer chunks from the rest before feeding them to a grinder, as not all chunks could prove to be optimal for grinding into the granulated material. The most pertinent contaminant that these elastomer chunks 116 could contain are metals, as metals can damage the grinder and/or other systems that could process the granulated material the elastomer chunks 116 can be processed into. In the example of used tire fill as the elastomer material 110, waste tire fill material could have collected metals over the course of their use, and it can be challenging to identify this accumulation on the waste tire fill material. A metal detector can be used to detect the presence of metals in the elastomer chunks 116, after which those identified elastomer chunks 116 can be separated from the rest of the elastomer chunks 116 before being introduced to a grinder. In a preferred embodiment, the elastomer chunks 116 can be sent to a conveyor belt on which the elastomer chunks 116 can be scanned by a metal detector. If a certain measurement is reached by the metal detector when scanning a particular elastomer chunk 116, that elastomer chunk 116 can be ejected or otherwise removed from the conveyor belt before that elastomer chunk reaches the grinder at the end of the conveyor belt pathway. The metal detection of the elastomer chunks 116 and the rejection of elastomer chunks containing metal may be automated steps in that the metal detectors can be positioned on a conveyor belt operative to remove particular chunks. Any type of metal detector known and used in the art can be implemented into this procedure. This step may allow for efficient use of a elastomer material 110, as even if it does contain a significant amount of metal, elastomer chunks 116 which are free of metal may still be extracted and used to make the granulated material. Alternatively, or additionally, the elastomer material 110 can be scanned with one or more metal detectors to detect for the presence of metal before extrusion. If a whole donut is being used as the elastomer material 110, this can include scanning the inner diameter and the outer diameter of the tire fill. To aid in this scanning process, the elastomer material 110 can be positioned, such as via suspending the elastomer material 110 on a sling (like a nylon or another non-metallic material), which can make it easier to scan the elastomer material 110. If no metal is found, the elastomer material 110 can be extruded without fear of damaging the extrusion system 100.

Looking now to FIG. 4, an exemplary tire filling system is shown. The tire filling system 200 may comprise a housing 204 which can house the tire 202 to be filled with a flatproofing material 206. The tire 202 may have an internal volume which may contain air 208. This air 208 can escape through a hole 212 in the tire 202 when the tire 202 is being filled with the flatproofing material 206. The hole 212 can be made by puncturing the tire 202, which can be done via, for example, an operator using a tool and/or with a machine operative to puncture the tire 202. The housing 204 itself may comprise the machine used to puncture the tire 202, in which case the tire 202 may be placed in the housing 204, putting the tire 202 in a proper position to be punctured by the machine. The flatproofing material 206 may comprise the granulated material produced from the aforementioned process of grinding the elastomer chunks 116. In this respect, the flatproofing material 206 could solely be comprised by the granulated material produced from the elastomer chunks 116. Alternatively, the flatproofing material 206 could also comprise additional substances such as a polyurethane component which could include, but is not strictly limited to, toluene diisocyanate, diphenylmethane diisocyanate, praraphenylene diisocyanate, toluidine diisocyanate, 1,5-naphthylene diisocyanate, polyester, polyether, polycaprolactone, polycarbonate, 1,4-butanediol, 1,3-propanediol, and combinations thereof. The granulated material may be mixed with one or more of these additional components to form the flatproofing material 206 slurry to be used to fill the tire 202. Alternatively, the components of the flatproofing material 206 could be sent to the tire 202 individually, wherein those components may mix together inside the tire 202 to form the flatproofing material 206. A combination of these two methodologies may be performed as well (for example, two components are mixed together, and that mixture is sent into the tire 202 along with a third component which altogether form the flatproofing material 206 inside the tire 202). Any combination of components used can be sent into the tire 202 simultaneously or sequentially.

A hose 210 may introduce the flatproofing material 206 into the tire 202, although alternative components and mechanisms that function similarly can be used to fill the tire 202 with the flatproofing material 206, either alongside the hose 210 or in alternative to the hose 210. One end of the hose 210 can be fluidly connected to a reservoir (not shown) containing a supply of flatproofing material 206 or subcomponents thereof while the other end of the hose 210 can be fluidly connected to the internal volume of the tire 202. The hose 210 or an equivalent component could be operative to feed the flatproofing material 206 into the tire 202 at a flow rate, and this flow rate could be varied throughout the filling process between a flow rate of zero (with no flatproofing material 206 being sent inside the tire 202), a maximum flow rate (which could depend on the construction and operability of the hose 210), and flow rate values in between. The hose 210 could be further operative to reverse the flow of flatproofing material 206, such as with a vacuum incorporated into the structure of the hose 210, to remove flatproofing material 206 if necessary to avoid over pressurization of the tire 202. Alternatively, a separate conduit fluidly connected to the flatproofing material 206 contained in the tire 202 may be used to remove the flatproofing material 206, optionally with the help of a vacuum. More than one hose 210 can be used in a tire filling system 200 so that a particular hose may introduce a particular component or a mixture of components of the flatproofing material 206.

The hose 210 could extend through the housing 204 (via, for example, the housing 204 having a port for the hose 210 to extend through) so that the reservoir holding the flatproofing material 206 can be located outside of the housing 204. The tire 202 could similarly have a port that the hose 210 can be coupled to in order to send the flatproofing material 206 into the tire 202. Alternatively, another hole, separate from the aforementioned hole 212 in the tire 202, could be made in the tire 202 through which the flatproofing material 206 can sent into the tire 202, and this hole can be sealed once the desired amount of flatproofing material 206 has been sent into the tire 202. As the flatproofing material 206 is introduced into the tire 202, the air 208 in the tire 202 can escape out from the tire 202 through the hole 212. Escaped air 214 escaping from the tire 202 can be measured by an air flow meter 220 operative to measure the flow rate of the escaped air 214 escaping from the tire 202. The air flow meter 220 may be positioned along a fluid pathway of the escaped air 214 so that the air flow meter 220 may give an accurate indication of the flow rate of escaped air 214 that has escaped from the tire 202.

The tire filling system 200 may comprise a duct 216 which, as will be shown, can help the air flow meter to measure the flow rate of the escaped air 214 more accurately. The duct 216 could have a passageway through which gases may travel through. The duct 216 can be coupled to the tire 202, and mechanisms built into the duct 216, the tire 202, and/or the housing 204 may assist in performing said coupling. The duct 216 can be made of a flexible material to allow the duct 216 to stretch so that it can be properly positioned and coupled to the tire 202, although ideally this flexible material would prevent gasses in the passageway from escaping through the material (e.g., no pores or voids for the gasses to leave the duct 216 through). This flexibility may also allow tires of differing sizes to be used in a tire filling system 200. The coupling of the duct 216 to the tire 202 may be associated with the hole 212 in the tire such that the passageway of the duct 216 is fluidly connected with the internal volume of the tire. Thus, escaped air 214 from the tire 202 may travel into the duct 216. This coupling of the duct 216 to the tire 202 may preferably cause most if not all of the escaped air 214 would travel into the passageway of the duct 216. Thus, the coupling could be an airtight seal to better ensure this outcome.

Additionally, the duct 216 may be coupled to the housing 204, and this coupling can be associated with an opening 218 of the housing 204 so that the passageway of the duct 216 is fluidly connected to the opening 218, allowing gasses to enter and exit the passageway of the duct 216 through the opening 218. If combined with the aforementioned coupling of the duct 216 to the tire 202, with said coupling being associated with the hole 212 in the tire 202, the escaped air 214 may escape from the tire 202 through the hole 212 and into the passageway of the duct 216, followed by escaping from the duct 216 through the opening 218 of the housing 204. This can be seen in the depiction of FIG. 4, in which air 208 in the tire 202 escapes through the hole 212, and the escaped air 214 rises up the duct 216 and out through the opening 218 of the housing 204.

At least a portion of the air flow meter 220 can be positioned in this fluid pathway of the escaped air 214 in the duct 216 so that the air flow meter 220 may measure the flow rate of the escaped air 214. In this more contained environment of the passageway of the duct 216, the air flow meter 220 may more accurately determine the amount of escaped air 214 that has escaped from the tire 202, since more of the escaped air 214 may now travel through the fan or otherwise interact with another similar detection element the air flow meter 220 may have to measure the flow rate of the escape air 214. The more accurate measurement of the flow rate of the escaped air 214 may thus allow an operator or a computer 238 gathering data from the air flow meter 220 to more readily monitor and thus more safely control the tire filling process, as will soon be shown. The positioning of the air flow meter 220 in the duct 216 may be accomplished via the air flow meter 220 being directly built into the duct 216 as a subcomponent of the duct 216 or alternatively the air flow meter 220 being an external component that can be coupled to the duct 216. If it is the latter case, then the coupling of the air flow meter 220 to the duct 216 may preferably not create another opening through which the escaped air 214 could escape through, as that could cause the readings of the air flow meter 220 to stary from the actual amount of escaped air 214.

The air flow meter 220 can be in communication with a computer 238, such as by a direct connection with a cable 222 or a wireless connection, allowing the computer 238 to collect and process the data gathered from the air flow meter 220. If the air 208 in the tire 202 cannot escape through the hole 212 as the flatproofing material 206 is introduced to the tire 202, which can happen due to the hole 212 not being properly made (i.e., not big enough, not deep enough into the tire 202) and/or the hole 212 becoming blocked, the tire 202 could become over pressurized and potentially explode. In order to avoid this outcome, the computer 238 receiving the measurements from the air flow meter 220 or the air flow meter 220 itself can notify an operator when the air flow rate measurements recorded by the air flow meter 220 have fallen to a low threshold value, such as via an LED light indicator and/or a sound notification. This threshold value may be preset and based on the type of tire 202 used, the type of flatproofing material used 206, etc. The operator may also be notified when the flow rate of the escaped air 214 drops below separate threshold values, like an intermediate threshold value above the aforementioned lower threshold value. One contemplated embodiment comprises 3 LED lights, green, yellow and red, with the yellow light turning on when the air flow rate of the escaped air 214 is getting low but not low enough to indicate that the filling process should be ceased. The green and red lights could let the operator know when to start and stop the filling process respectively.

Once a low reading below the low threshold value is obtained by the air flow meter 220, the operator can stop filling the tire 202 with the flatproofing material 206 and investigate the tire 202, which could comprise determining the amount of air 208 left in the tire 202, determining the amount of flatproofing material 206 present in the tire 202, and/or examining the hole 212 in the tire 202. The operator can then decide what to do next in light of this information. If the low flow rate measurement from the air flow meter 220 was a result of the hole 212 being blocked or not properly made, and the tire 202 has started to become over pressurized with air 208 and flatproofing material 206, the hole 212 can be unblocked/fixed. Some of the built-up air 208 can be allowed to escape from the tire 202, after which more flatproofing material 206 can be fed into the tire 202. If the amount of flatproofing material 206 in the tire 202 is below what is expected, the operator can examine the hose 210 to ensure the flatproofing material 206 is being pumped correctly and that there are no major blockages impeding the flow of flatproofing material 206. If most of the air 208 has escaped from the tire 202 and the tire 202 isn't at risk of exploding, the operator may continue to fill the tire 202 with more flatproofing material until the tire 202 is sufficiently filled with the flatproofing material 206. The housing 204 could incorporate a weight sensor, which could give insight as to how much flatproofing material 206 and/or air 208 is in the tire 202.

The operator may control the tire filling process with a control mechanism 224. The control mechanism 224 may have a start button 226 and an off button 228 to start and cease the process of filling the tire 202 with the flatproofing material 206 as well as a flowrate knob 230 to raise or lower the flowrate of flatproofing material 206 into the tire 202. Rotating the flowrate knob 230 could cause the flow rate of the flatproofing material 206 through the hose 210 to be modified, such as by opening or closing a valve in the hose 210. The control mechanism 224 can be connected to the hose 210 through direct connection 240 so that it can act upon the hose 210 in response to rotation of the flowrate knob 230. The computer 238 may receive data as to how much flatproofing material 206 should have been pumped inside the tire 202 by processing the settings of the flowrate knob 230 over a time interval. This expected value can be compared to the actual amount of flatproofing material 206 in the tire 202 determined when investigating the tire 202 to see if there is has been a problem with the filling process. In case the tire 202 is at risk of overfilling and exploding due to over pressurization, the operator can press the emergency stop button 232 which can facilitate the steady cessation of flow of flatproofing material 206 into the tire 202 (a sudden cessation of flow may cause a pressure spike in the pumping equipment). The control mechanism 224 need not be limited to the depiction shown, as the buttons 224, 226, 232 and knob 230 could be replaced with alternative mechanisms like switches and levers. One preferred embodiment comprises a foot pedal, to start or stop the flow of flatproofing material 206 into the tire 202. The flow of flatproofing material 206 into the tire 202 can also be controlled through different control mechanisms like the computer 238, a handheld device, a panel built directly into the housing 204, and more. The overall tire filling process could alternatively be automated, as the computer 238 could control the pumping of flatproofing material 206 into the tire 202, react to the readings of the air flow meter 220, investigate the tire 202, and start/stop the filling process as necessary.

Once the tire 202 has been filled with flatproofing material 206 to a sufficient degree, which those skilled in the art would readily understand when such a point is reached, the hole 212 in the tire 202 may be sealed. Additional flatproofing material 206 can be pumped into the tire 202 thereafter to reach a specified internal pressure (this specified pressure can depend on the type of tire and the intended application of the tire), which may lead to the completed flatproofed tire product. If a hole was made in the tire 202 for the hose 210 to supply flatproofing material 206 through, that hole may also be sealed to arrive at the final flatproofed tire product. The sealing of these holes could be an airtight seal (e.g., a hermetic seal) and the sealing of the hole could comprise mending portions of the tire 202 together, applying adhesives to the tire 202, applying a material like a elastomer piece to cover the hole in the tire, or combinations thereof. The flatproofing material 206, when hardened, could also naturally form the desired seal.

The above description is given by way of example, and not limitation. Given the above disclosure, one skilled in the art could devise variations that are within the scope and spirit of the invention disclosed herein, including various methods and systems for producing elastomer chunks and filling tires with flatproofing materials. Further, the various features of the embodiments disclosed herein can be used alone, or in varying combinations with each other and are not intended to be limited to the specific combination described herein. Thus, the scope of the claims is not to be limited by the illustrated embodiments.

1. A method of producing a flatproofed tire, the method comprising the steps of:
a) extruding an elastomer material through an extrusion die to produce two or more elastomer chunks;
b) grinding the two or more elastomer chunks to produce a granulated material;
c) at least partially filling a tire with at least some of the granulated material, the tire having an internal volume containing air, the filling of the tire with the at least some of the granulated material causing at least some of the air to escape from the tire through a hole in the tire;
d) measuring the flow rate of at least some of the air escaping from the tire;
e) ceasing the filling of the tire with the at least some of the granulated material; and
f) sealing the hole in the tire;
wherein the step of ceasing the filling of the tire with at least some of the granulated material is performed after the measured flow rate of the air escaping from the tire drops below a threshold value.

2. The method of claim 1, wherein the method further comprises a step of investigating the tire.

3. The method of claim 2, wherein after the step of investigating the tire, the method further comprises a step of at least partially filling the tire with at least some of the remaining granulated material and a step of ceasing the filling of the tire with the at least some of the remaining granulated material.

4. The method of claim 2, wherein the step of investigating the tire comprises determining the amount of air contained in the tire, determining the amount of granulated material contained in the tire, determining if the hole has been blocked, or combinations thereof.

5. The method of claim 1, wherein the extrusion die has one or more edges that define one or more voids therebetween, and wherein at least one of the one or more edges are pointed.

6. The method of claim 1, wherein prior to the step of extruding the elastomer material, the method further comprises a step of scanning the elastomer material with a metal detector.

7. The method of claim 1, wherein after the step of extruding the elastomer material, the method further comprises a step of scanning the two or more elastomer chunks with a metal detector, and wherein the method further comprises a step of separating one or more elastomer chunks containing metal from the two or more elastomer chunks.

8. The method of claim 1, wherein the at least some of the granulated material is mixed with a polyurethane, the polyurethane being selected from toluene diisocyanate, diphenylmethane diisocyanate, praraphenylene diisocyanate, toluidine diisocyanate, 1,5-naphthylene diisocyanate, polyester, polyether, polycaprolactone, polycarbonate, 1,4-butanediol, 1,3-propanediol, or combinations thereof.

9. The method of claim 1, wherein the method further comprises a step of making the hole in the tire by puncturing the tire.

10. The method of claim 1, wherein the method further comprises a step of positioning an air flow meter, the positioning of the air flow meter emplacing at least a portion of the air flow meter in a fluid pathway of the at least some of the air escaping from the tire, the air flow meter being operative to measure the air flow rate of the at least some of the air escaping from the tire.

11. The method of claim 10, wherein the method further comprises a step of coupling a duct to the tire, the duct having a passageway, the coupling of the duct to the tire being associated with the hole in the tire so that the passageway of the duct is fluidly connected to the internal volume of the tire; and wherein the at least a portion of the air flow meter is positioned in the passageway of the duct.

12. A flatproofed tire system for recycling an elastomer material and producing a flatproofed tire, the flatproofed tire system comprising an extrusion system, the extrusion system comprising:
a piston, the piston being movable in at least a direction of extrusion; and
an extrusion die having one or more edges defining one or more voids therebetween;
the piston being operative to extrude the elastomer material through the extrusion die when the piston is moved in the direction of extrusion, the extrusion of the elastomer material through the extrusion die producing two or more elastomer chunks, the two or more elastomer chunks being operative to be received by a grinder to produce a granulated material;
the flatproofed tire system further comprising a tire filling system, the tire filling system comprising:
a housing having an opening; and
a duct having a passageway, the duct being operative to be coupled to the housing, the coupling of the duct to the housing being associated with the opening in the housing so that the passageway of the duct is fluidly connected to the opening of the housing, the duct further being operative to be coupled to a tire having an internal volume containing air, the coupling of the duct to the tire being associated with a hole in the tire so that the passageway of the duct is fluidly connected to the internal volume of the tire to provide a fluid pathway for the air contained in the tire to escape from the tire and into the passageway.

13. The flatproofed tire system of claim 12, wherein the tire filling system further comprises an air flow meter, at least a portion of the air flow meter being operative to be positioned in the passageway of the duct, the air flow meter being further operative to measure the flow rate of the air escaping from the tire when the at least a portion of the air flow meter is positioned in the passageway of the duct.

14. The flatproofed tire system of claim 12, wherein the tire filling system further comprises a hose, the hose being operative to supply the granulated material to the tire.

15. The flatproofed tire system of claim 12, wherein the piston is movable in the direction of extrusion at a variable speed, the variable speed being adjustable between a speed of zero, a maximum speed, and speeds therebetween.

16. The flatproofed tire system of claim 12, wherein at least one of the one or more edges of the extrusion die are pointed.

17. The flatproofed tire system of claim 12, wherein the extrusion system further comprises a metal detector, the metal detector being operative to scan the two or more elastomer chunks and identify if any of the two or more elastomer chunks contains a metallic species.

18. The flatproofed tire system of claim 12, wherein the housing further comprises a weight sensor operative to measure the weight of the tire.

19. The flatproofed tire system of claim 12, wherein the hose is operative to stop supplying the granulated material to the tire when the flow rate of the air escaping from the tire measured by the air flow meter drops below a threshold value.

20. The flatproofed tire system of claim 12, wherein the hose is further operative to supply the granulated material to the tire at a variable flow rate, the variable flow rate being adjustable between a flow rate of zero, a maximum flow rate, and flow rates therebetween.
